(19) United States
(12) Patent Application Publication
(10) Pub. No.: US 2007/0033071 A1
(43) Pub. Date: Feb. 8, 2007

(54) Method and system for capitation of medical supplies

(76) Inventor: Reinhold Schmieding, Naples, FL (US)

Correspondence Address: DICKSTEIN SHAPIRO LLP, 1825 EYE STREET NW, Washington, DC, 20006-5403, US

(21) Appl. No.: 11/498,829

(22) Filed: Aug. 4, 2006

Related U.S. Application Data
(60) Provisional application No. 60/705,496, filed on Aug. 5, 2005.

(51) Int. Cl. G06Q 10/00; H04M 15/00; G06F 17/00

(52) U.S. Cl. 705/2; 705/400; 705/34

(57) ABSTRACT

Methods for capitation of medical supplies including determining a fixed price for medical supplies to be used in a medical procedure, and billing a buyer based on the number of medical procedures performed times the fixed price are provided.

This application claims the benefit of U.S. Provisional Application Ser. No. 60/705,496, filed Aug. 5, 2005 which is incorporated herein in its entirety.

### BACKGROUND OF THE INVENTION

The term “capitation” refers to, for example, a predetermined per-person or per-procedure payment to provide specified services. The predetermined payment can be fixed or adjusted based on actuarial projections of the requirements for the medical services. Capitation provides buyers with predictable costs associated with a given level of service. However, in certain circumstances where third-party reimbursement is required, capitation may introduce uncertainty regarding whether buyers will be fully reimbursement for expenses associated with medical services.

The transaction costs resulting from negotiating reimbursement schedules for the equipment and supplies necessary for various medical procedures impose a serious burden on medical facilities. Medical facilities may be unable to obtain the necessary equipment and supplies to provide medical services. Alternatively, the costs may be passed on to patients resulting in increased unreimbursed health care costs. Patients may be forced to delay medical procedures, forgo them altogether, or use another medical facility. Insurance companies also bear additional transaction costs resulting from increased staff time devoted to negotiating reimbursement schedules for various procedures. Increased costs to insurance companies are likely to be passed on to policy holders in the form of increased premiums. Finally, the manufacturers and suppliers of medical and surgical equipment and supplies have increased costs resulting from delayed payments and the costs of carrying excess inventory or, alternatively, the delays associated with not maintaining sufficient inventory to meet a sudden increase in demand.

Medical equipment and supplies may enter into requirements contracts with their customers. However, there is no assurance that the terms negotiated by the suppliers and customers are on terms acceptable to insurance companies. What is needed is a simplified method and system for capitation of medical supplies.

### SUMMARY OF THE INVENTION

To address the disadvantages encountered in the prior art, one object of the present invention to streamline capitation transactions for supplies between medical facilities, insurance companies, and suppliers.

It is also an objective of the present invention to provide a method to reduce the transaction costs resulting from negotiating reimbursement schedules between a medical facility and an insurance company.

It is a further objective of the present invention to provide a method to reduce the transaction costs resulting from re-negotiating contracts between a medical facility and a supplier with an insurance company.

The present invention provides exemplary methods for capitation of medical supplies by determining a fixed price for supplies needed for a medical procedure, and billing a buyer a price calculated by multiplying the number of medical procedures performed by the fixed price. In a preferred embodiment of the invention, the method and system relates to establishing a fixed price for providing a predetermined amount of medical supplies to a medical facility.

Other features and advantages of the present invention will become apparent from the following description of the invention which refers to the accompanying drawings.

### BRIEF DESCRIPTION OF THE DRAWING

FIG. 1 is a flowchart illustrating the method in accordance with an embodiment of the present invention.

### DETAILED DESCRIPTION OF EMBODIMENTS OF THE INVENTION

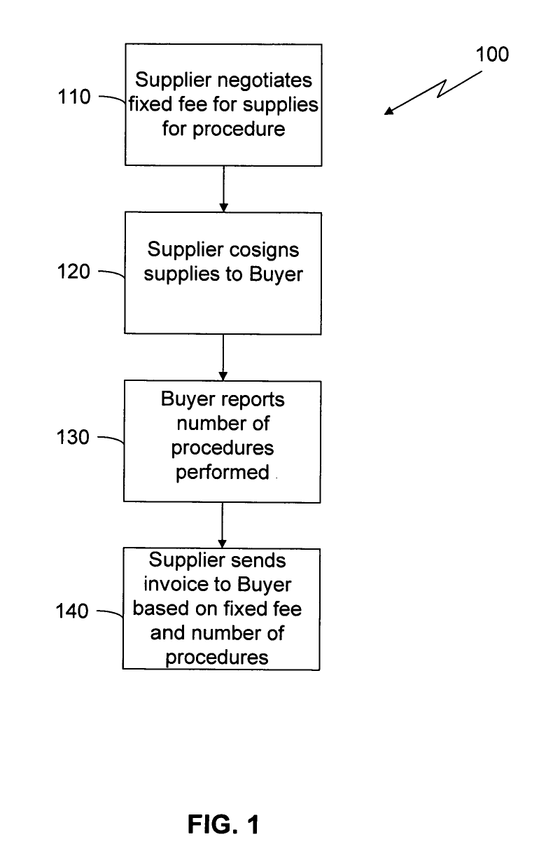

The present invention provides methods for capitation of medical supplies. One embodiment of the invention is the method 100 illustrated in the flow chart shown in FIG. 1. Referring to FIG. 1, a manufacturer or supplier of medical equipment and/or supplies (“Supplier”) negotiates a fixed fee for providing the equipment and/or supplies needed for a medical procedure with an insurance company (step 110). Alternatively, the fixed fee may be negotiated between the Supplier and an insurance company. Next, in step 120, the Supplier consigns the equipment and/or supplies necessary for a given medical procedure to a medical facility (“Buyer”), such as a surgical center, facility, or hospital. The Buyer reports the number of procedures conducted in a given period of time (e.g., daily, weekly, monthly, annually) to the Supplier and the insurance company in step 130. In step 140, the Supplier sends an invoice to the Buyer based on the total number of procedures multiplied by the fixed price per procedure.

In another embodiment of the invention, the fixed price is determined according to the estimated amount of equipment and/or supplies for a given medical procedure. Depending on the volume of equipment and/or supplies needed, a partially discounted, or fully discounted price per procedure can be negotiated. Certain procedures may require a larger volume of equipment and/or supplies or the equipment and/or supplies may need to be maintained in a certain condition before or during the procedure (e.g., sterility, temperature). The requirements of a given procedure can be taken into account when negotiating the amount of the fixed price per procedure. In addition, the parties may agree to adjust the fixed price periodically to reflect the actual requirements for the procedures as measured during a given time period.

In yet another embodiment of the invention, the amount of medical supplies consigned to the Buyer is an estimated amount of medical supplies required for an average number of medical procedures performed during the predetermined period of time and further includes an additional estimated amount of medical supplies required for an average number of said medical procedures performed during a portion of the predetermined period of time. For example, if the Buyer performs an average of 20 procedures per week and the predetermined period is two weeks long, the Supplier could cosign enough supplies for 40 procedures to cover the two week period plus supplies for an additional 20 procedures to cover an extra week.

In a further embodiment, the Supplier further consigns an amount of medical supplies to replace the amount of medical supplies used by the Buyer during the predetermined period of time and bills the Buyer during a subsequent predetermined period of time.

### EXAMPLE

An arthroscopic surgical center (ASC) desires to obtain a sufficient quantity of suture anchors and associated disposables to perform various arthroscopic surgical shoulder procedures, such as rotator cuff repair. On average, the ASC performs 20 rotator cuff procedures each week. According to the ASC's internal procedures, a two week supply of anchors and disposables necessary to perform a shoulder repair procedure is required to be available on site at any given time. The Supplier negotiates a price for providing the anchors and disposables to the ASC on a price per procedure basis. The Supplier submits the negotiated price to the ASC's insurance company for approval. The insurance company approves the negotiated price. The Supplier enters into a contract with the ASC to provide the suture anchors and disposables in sufficient quantities to meet the expected need to perform 20 procedures per week and maintain a two week supply of anchors and disposables (i.e., 40 procedures). Every two weeks, the ASC reports the actual number of procedures performed to the Supplier and the insurance company. The Supplier replenishes the anchors and disposables and sends the ASC an invoice reflecting the actual number of procedures performed in the previous two weeks. The ASC remits payment of the invoice and requests reimbursement from the insurance company. The Supplier and ASC agree to review the fixed price once a year to determine if the price should be adjusted.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for capitation of medical supplies, comprising:
determining a fixed price for medical supplies to be used in a medical procedure;
consigning the medical supplies for at least one of said medical procedures to a buyer;
recording the number of said medical procedures performed during a predetermined period of time; and
billing the buyer based on the number of said medical procedures performed times the fixed price.

2. The method of claim 1, wherein the fixed price is determined by a negotiation between a supplier of the medical supplies and the buyer.

3. The method of claim 2, wherein an insurance company approves the fixed price.

4. The method of claim 1, wherein the fixed price is determined by a negotiation between a supplier of the medical supplies and an insurance company.

5. The method of claim 1, wherein the fixed price is determined based on an estimated amount of medical supplies to be used in said medical procedure.

6. The method of claim 5, wherein the fixed price is periodically adjusted to reflect the average amount of medical supplies used in said medial procedure.

7. The method of claim 1, wherein the fixed price is reduced based on the number of said medical procedures performed during the predetermined period of time.

8. The method of claim 1, wherein the fixed price is adjusted based on the cost of maintaining the medical supplies before or during said medical procedures.

9. The method of claim 8, wherein maintaining the medical supplies comprises maintaining the medical supplies within a predetermined temperature range.

10. The method of claim 8, wherein maintaining the medical supplies comprises maintaining the sterility of the medical supplies.

11. The method of claim 1, wherein an amount of medical supplies consigned to the buyer is an estimated amount of medical supplies required for an average number of said medical procedures performed during the predetermined period of time plus an additional estimated amount of medical supplies required for an average number of said medical procedures performed during a portion of the predetermined period of time.

12. The method of claim 11, wherein the supplier further consigns an amount of medical supplies to replace an amount of medical supplies used by the buyer during the predetermined period of time.

13. The method of claim 1, wherein the buyer is billed in a subsequent predetermined period of time.

14. The method of claim 1, wherein the buyer is a medical facility.

15. A method for capitation of medical supplies, comprising:
negotiating a fixed price for medical supplies to be used in a medical procedure by negotiations between a supplier of the medical supplies and an insurance company;
consigning the medical supplies for multiple said medical procedures to a medical facility;
reporting a number of said medical procedures performed during a predetermined period of time by the medical facility to the supplier and the insurance company; and
sending an invoice based on the number of said medical procedures performed times the fixed price to the medical facility from the supplier.
